(19) United States
(12) Patent Application Publication
(10) Pub. No.: US 2024/0396167 A1
(43) Pub. Date: Nov. 28, 2024

(54) COMPOSITE SEPARATOR AND ELECTROCHEMICAL APPARATUS

(71) Applicant: ZHUHAI COSMX BATTERY CO., LTD., Zhuhai (CN)

(72) Inventors: Fei HE, Zhuhai (CN); Suli LI, Zhuhai (CN)

(73) Assignee: ZHUHAI COSMX BATTERY CO., LTD., Zhuhai (CN)

(21) Appl. No.: 18/796,669

(22) Filed: Aug. 7, 2024

Related U.S. Application Data
(63) Continuation-in-part of application No. PCT/CN2022/142546, filed on Dec. 27, 2022.

(30) Foreign Application Priority Data
Feb. 18, 2022 (CN) 202210153532.3

(51) Int. Cl. H01M 50/446; H01M 10/0525; H01M 50/417; H01M 50/449; H01M 50/489

(52) U.S. Cl. CPC H01M 50/446; H01M 50/417; H01M 50/449; H01M 50/489; H01M 10/0525

(57) ABSTRACT

Disclosed are a composite separator and an electrochemical apparatus. The composite separator includes a polymer film and a functional coating disposed on at least one surface of the polymer film, where the functional coating contains inorganic particles and organic particles; a particle size D90₁ of the inorganic particles and a particle size D90₂ of the organic particles satisfy: 0.01×D90₂≤D90₁≤0.5×D90₂, where D90₁ and D90₂ represent particle sizes of inorganic particles and organic particles, respectively, at a cumulative volume of 90% from small particle sizes in the volume-based particle size distribution. The composite separator has excellent thermal shrinkage-resistant performance and interface bonding performance, and can take both cycling performance and high safety of an electrochemical apparatus into account when being used in the electrochemical apparatus.

### CROSS-REFERENCE TO RELATED APPLICATIONS

The present application is a continuation-in-part (CIP) of International Application No. PCT/CN2022/142546, filed on Dec. 27, 2022, which claims priority to Chinese Patent Application No. 202210153532.3, filed with the China National Intellectual Property Administration on Feb. 18, 2022 and entitled “COMPOSITE SEPARATOR AND ELECTROCHEMICAL APPARATUS”. All of the aforementioned applications are incorporated herein by reference in their entireties.

### TECHNICAL FIELD

The present disclosure relates to the technical field of electrochemical apparatuses, and in particular, to a composite separator and an electrochemical apparatus.

### BACKGROUND

Having advantages of high energy density, high operating voltage, wide service temperature range, long service life, and high environmental friendliness, lithium-ion batteries are widely used in fields such as mobile phones, notebook computers, electric tools, energy storage projects, and electric vehicles. Meanwhile, a quantity of fire breakout and explosion incidents of batteries is increasingly high; and safety problems are still one of major concerns of consumers about lithium-ion batteries. Being an important component of a lithium-ion battery, a separator is used to avoid contact between a positive electrode and a negative electrode while allowing lithium ions to migrate in an electrolyte. The separator may affect performance of interfaces between the electrodes and the electrolyte, thereby having a significant influence on performance of the battery.

In the prior art, to improve safety of a battery, a surface of a polyolefin separator is generally coated with a heat-resistant coating and a bonding coating. During a furnace temperature test, the heat-resistant coating can restrain shrinkage of the polyolefin separator, to ensure passing of lithium ions and avoid short-circuit contact between the positive electrode and the negative electrode. Therefore, a pass rate of furnace temperature tests of electrochemical cells is increased; and the battery can be prevented from short-circuiting and exploding. The bonding coating can not only prevent the heat-resistant coating from falling off from the separator to improve the bonding force of the separator and the safety of the battery, but also improve the performance of interfaces between the polyolefin separator and the electrodes to greatly prolong the cycle life of the battery. However, existence of the heat-resistant coating and the bonding coating increases the thickness of the separator. As a result, the energy density of the battery is reduced. Further, the bonding coating and the heat-resistant coating are combined to decrease the thickness of the separator, thereby improving the energy density. However, after the heat-resistant coating is combined with the bonding coating, the shrinkage performance and interface bonding performance of the heat-resistant bonding coating of the separator are greatly reduced, which affects the safety performance of the battery. As a result, it is hard for a separator in the prior art to take both high energy density and high safety of a battery into account.

### SUMMARY

The present disclosure provides a composite separator and an electrochemical apparatus. The composite separator has excellent thermal shrinkage-resistant performance and interface bonding performance, and can take both cycling performance and safety of an electrochemical apparatus into account when being used in the electrochemical apparatus.

According to a first aspect of the present disclosure, a composite separator is provided. The composite separator includes a polymer film and a functional coating disposed on at least one surface of the polymer film, where the functional coating contains inorganic particles and organic particles; a particle size D90₁ of the inorganic particles and a particle size D90₂ of the organic particles satisfy: 0.01×D90₂≤D90₁≤0.5×D90₂, where D90₁ represents a particle size of inorganic particles at a cumulative volume of 90% from small particle sizes in the volume-based particle size distribution; and D90₂ represents a particle size of organic particles at a cumulative volume of 90% from small particle sizes in the volume-based particle size distribution.

According to a second aspect of the present disclosure, a method for preparing the composite separator according to the first aspect is provided, including: mixing inorganic particles and organic particles to form a mixed coating material; coating at least one surface of a polymer film with the mixed coating material to form a functional coating; and performing drying to obtain the composite separator.

According to a third aspect of the present disclosure, an electrochemical apparatus is provided, including the foregoing composite separator.

Implementation of the present disclosure has at least the following beneficial effects.

In the present disclosure, the functional coating is disposed on the polymer film; the organic particles and the inorganic particles are added in the functional coating; and the particle sizes of the inorganic particles and the organic particles are controlled to satisfy: 0.01×D90₂≤D90₁≤0.5×D90₂. In a structural system of the composite separator, existence of the organic particles can not only increase a bonding force between the functional coating and the polymer film to improve the structural stability of the composite separator, but also improve the interface bonding performance of the composite separator to increase strength of a bonding force between the composite separator and an electrode plate, thereby avoiding phenomena such as a short circuit caused by staggered movement between the composite separator and the electrode plate. In addition, due to the inorganic particles serving as a support network of the functional coating, the functional coating has relatively high strength, thereby restraining thermal shrinkage or the like of the composite separator. This makes the composite separator have excellent thermal shrinkage-resistant performance. Therefore, performance such as bonding performance and thermal shrinkage-resistant performance of the composite separator can be improved by using the synergistic effect of an inorganic-organic composite structure, thereby improving the safety performance of the electrochemical apparatus, effectively resolving problems such as fire breakouts and explosions of electrochemical apparatuses such as a lithium-ion battery, and improving performance such as cycling performance of the electrochemical apparatus. In addition, a plurality of layers of structures such as a bonding layer and a heat-resistant coating do not need to be disposed on a polyolefin separator in the present disclosure. This further facilitates improvement of the energy density of the electrochemical apparatus using the composite separator.

### BRIEF DESCRIPTION OF THE DRAWINGS

FIG. 1 is a scanning electron microscope (SEM) image of a composite separator in Example 1 of the present disclosure.

FIG. 2 is an SEM image of a composite separator in Example 1 of the present disclosure.

FIG. 3 is an SEM image of a composite separator taken after a battery in Example 1 of the present disclosure is disassembled.

### DETAILED DESCRIPTION OF THE EMBODIMENTS

To help those skilled in the art better understand the solutions of the present disclosure, the following further describes the present disclosure in detail.

The present disclosure provides a composite separator. The composite separator includes a polymer film and a functional coating disposed on at least one surface of the polymer film, where the functional coating contains inorganic particles and organic particles; a particle size D90₁ of the inorganic particles and a particle size D90₂ of the organic particles satisfy: 0.01×D90₂≤D90₁≤0.5×D90₂, where D90₁ represents a particle size of inorganic particles at a cumulative volume of 90% from small particle sizes in the volume-based particle size distribution; and D90₂ represents a particle size of organic particles at a cumulative volume of 90% from small particle sizes in the volume-based particle size distribution.

D90 of the particles may be measured according to a wet method using a laser particle size analyzer.

In the present disclosure, the polymer film is a separator formed by a polymer, and contains the polymer, for example, contains polyolefin. The polymer film may be a conventional polymer separator in the art. In some preferred embodiments, the polymer film may be specifically a polymer microporous film. In a specific implementation process of the present disclosure, a polyethylene microporous film is used as the polymer film.

In some embodiments, the functional coating is disposed on one or two surfaces of the polymer film. Preferably, a first functional coating and a second functional coating are respectively disposed on two surfaces (on two sides) of the polymer film. Thicknesses of the first functional coating and the second functional coating may be the same or may be different.

In some embodiments, a ratio of a mass of the inorganic particles to a total mass of the inorganic particles and the organic particles is greater than 0 and less than 0.9. In other words, a percentage of the mass of the inorganic particles in the total mass of the inorganic particles and the organic particles is greater than 0 and not greater than 90%. For example, a ratio of the mass of the inorganic particles to a mass of the organic particles ranges from 0.1:1 to 9:1, for example, is 0.1:1, 0.5:1, 1:1, 1.5:1, 2:1, 2.5:1, 3:1, 3.5:1, 4:1, 4.5:1, 5:1, 5.5:1, 6:1, 6.5:1, 7:1, 8:1, 9:1, or in a range formed by any two of the foregoing values.

Generally, the particle size D90₁ of the inorganic particles satisfies: 0.01 μm<D90₁<10 μm, preferably, 0.01 μm<D90₁≤7.5 μm. In some embodiments, 0.01 μm<D90₁≤1.5 μm. For example, D90₁ is 0.02 μm, 0.1 μm, 0.15 μm, 0.2 μm, 0.3 μm, 0.4 μm, 0.5 μm, 0.6 μm, 0.7 μm, 0.8 μm, 0.9 μm, 1 μm, 1.1 μm, 1.15 μm, 1.2 μm, 1.3 μm, 1.4 μm, 1.5 μm, or in a range formed by any two of the foregoing values.

In some embodiments, 0.01 μm<D90₁≤1 μm.

Generally, the particle size D90₂ of the organic particles satisfies: 1 μm<D90₂<15 μm. In some embodiments, 2 μm≤D90₂<15 μm. For example, D90₂ is 2 μm, 3 μm, 4 μm, 5 μm, 6 am, 8 μm, 10 μm, 12 μm, 14 μm, 15 μm, or in a range formed by any two of the foregoing values.

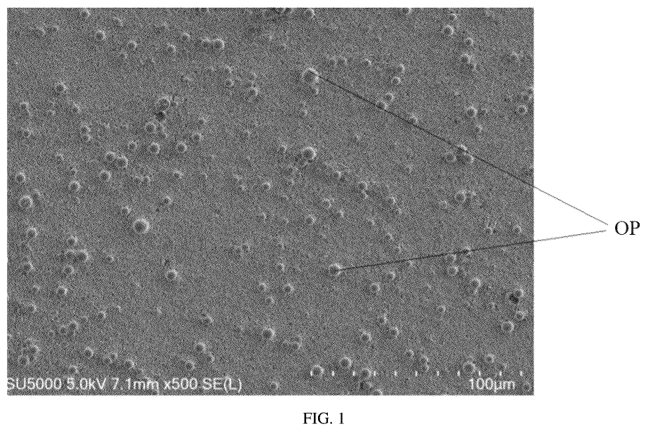

Generally, a thickness t of the functional coating ranges from 0.5 μm to 10 μm. In some embodiments, t ranges from 1 μm to 10 μm, for example, is 1 μm, 1.8 μm, 2 μm, 2.1 μm, 2.2 μm, 3 μm, 3.5 μm, 3.9 μm, 4 μm, 4.1 μm, 5 μm, 6 μm, 7 μm, 8 μm, 10 μm, or in a range formed by any two of the foregoing values. t is a thickness of a functional coating on one side of the polymer film. A method for testing the thickness includes: cutting out a composite separator sample having a width of 5 mm and a length of 20 mm with a blade; carrying out grinding and cutting with an argon ion grinder (IM4000 Plus, Hitachi); measuring the thickness of the functional coating on the side of the polymer film with a Hitachi scanning electron microscope (SU5000, Hitachi) having a magnification factor of 8K, where measurement positions include 6 protruded positions (the protruded positions are, for example, organic particles marked in FIG. 1, which have obvious height differences from a plane in FIG. 1) and 6 un-protruded positions (for example, the plane in FIG. 1); calculating an average value of the measured 12 pieces of data; and using the average value as the thickness of the functional coating on the side.

In the present disclosure, the particle size D90₁ of the inorganic particles, the particle size D90₂ of the organic particles, and the thickness t of the functional coating in the composite separator satisfy not only the foregoing conditions, but also the following condition: D90₁<t<D90₂. The particle size D90₁ of the inorganic particles, the particle size D90₂ of the organic particles, and the thickness t of the functional coating belong to parameters of a same functional coating on one side.

In some embodiments, the inorganic particles contain at least one of aluminum oxide, boehmite, magnesium hydroxide, silicon dioxide, barium sulfate, zirconium oxide, calcium oxide, titanium dioxide, or cerium dioxide.

In some embodiments, the organic particles contain at least one of polytetrafluoroethylene, polyvinylidene fluoride, polyvinylidene fluoride-hexafluoropropylene, polyacrylonitrile, polymethyl methacrylate, polyacrylic acid, polyacrylic acid ester, styrene-butadiene rubber, polyvinyl alcohol, polyvinyl acetate, polyacrylamide, phenolic resin, epoxy resin, waterborne polyurethane, polystyrene, polyethylene acrylate, an ethylene-vinyl acetate copolymer, an acrylic multicomponent copolymer, lithium polystyrene sulfonate, pure styrene latex, polyvinylidene difluoride-trichloroethylene, polyvinylidene difluoride-chlorotrifluoroethylene, or a copolymer; and the copolymer includes a copolymer obtained by copolymerizing at least two of polytetrafluoroethylene, polyvinylidene fluoride, polyvinylidene fluoride-hexafluoropropylene, polyacrylonitrile, polymethyl methacrylate, polyacrylic acid, polyacrylic acid ester, styrene-butadiene rubber, polyvinyl alcohol, polyvinyl acetate, polyacrylamide, phenolic resin, epoxy resin, waterborne polyurethane, polystyrene, polyethylene acrylate, an ethylene-vinyl acetate copolymer, an acrylic multicomponent copolymer, lithium polystyrene sulfonate, pure styrene latex, polyvinylidene difluoride-trichloroethylene, polyvinylidene difluoride-chlorotrifluoroethylene, polyvinylidene fluoride-methacrylic acid, polystyrene-methacrylic acid, or polyethylene acrylate-methacrylate-methylstyrene, where polyvinylidene fluoride-hexafluoropropylene means a copolymer of polyvinylidene fluoride-hexafluoropropylene (PVDF-HFP).

Specifically, the organic particles include an unmodified polymer and/or a modified polymer. For example, polyvinylidene fluoride includes unmodified polyvinylidene fluoride and/or modified polyvinylidene fluoride. A modification manner of the modified polymer may be a conventional modification manner in the art, for example, may be block modification (for example, a polymethacrylate-vinylidene fluoride block copolymer or acrylate copolymerized and modified polyvinyl acetate) or graft modification (for example, maleic anhydride-grafted polystyrene).

In an embodiment, the modified polymer contains at least one of a polymethacrylate-vinylidene fluoride block copolymer, a maleic anhydride-grafted polystyrene polymer, or acrylate copolymerized and modified polyvinyl acetate.

In some embodiments, an air permeability value of the composite separator ranges from 30 s to 1000 s, for example, is 30 s, 100 s, 200 s, 300 s, 400 s, 500 s, 600 s, 700 s, 800 s, 900 s, or 1000 s.

In some embodiments, an air permeability value of the polymer film ranges from 30 s to 1000 s, for example, is 30 s, 100 s, 200 s, 300 s, 400 s, 500 s, 600 s, 700 s, 800 s, 900 s, or 1000 s.

In some embodiments, the air permeability value of the composite separator is 0 s to 200 s greater than the air permeability value of the polymer film.

The air permeability value is time required for a specific volume of air to pass through a specific area of the polymer film or the composite separator under room temperature and normal pressure. The air permeability value may be a Gurley air permeability value. In a specific implementation process of the present disclosure, the Gurley air permeability value of the polymer film or the composite separator is tested with a Gurley air permeability tester. The Gurley air permeability value of the polymer film or the composite separator is tested according to a conventional method in the art, for example, a test standard for a GB/T36363-2018 polyolefin separator for lithium-ion batteries, or may be tested according to a test standard of an ASTM D1434-1982(2003) test method for testing air permeability of a plastic film and sheeting.

In some embodiments, a thickness a of the polymer film satisfies: 3 μm≤a≤25 μm, for example, is 3 μm, 4 μm, 5 μm, 6 μm, 7 μm, 7.1 μm, 8 μm, 9 μm, 10 μm, 12 μm, 15 μm, 18 μm, 20 μm, 25 μm, or in a range formed by any two of the foregoing values.

In some embodiments, a thickness b of the composite separator satisfies: 3 μm<b≤30 m. Preferably, b satisfies: 4 μm≤b≤30 μm, for example, is 4 μm, 5 μm, 6 μm, 8 μm, 9 μm, 10 μm, 10.9 μm, 11 μm, 11.1 μm, 11.4 μm, 11.5 μm, 12 μm, 14 μm, 15 μm, 15.2 μm, 16 μm, 18 μm, 20 μm, 25 μm, 30 μm, or in a range formed by any two of the foregoing values. A method for testing the thickness b of the composite separator includes: cutting out a separator sample having an area of 200 mm*200 mm; taking 12 samples from the area of 200 mm*200 mm at intervals of 30 mm with a micrometer; testing thicknesses of the separators to obtain 12 pieces of data; calculating an average value of the data; and using the average value as the thickness of the composite separator.

A method for preparing the composite separator provided in the present disclosure includes: mixing inorganic particles and organic particles to form a mixed coating material; coating at least one surface of the polymer film with the mixed coating material; and carrying out drying to form a functional coating and obtain the composite separator.

In a specific implementation process of the present disclosure, the inorganic particles are first dispersed in a first solvent, to form a first mixed solution; then the organic particles are dispersed in a second solvent, to form a second mixed solution; the first mixed solution and the second mixed solution are evenly dispersed via stirring, to form a third mixed solution; at least one surface of the polymer film is evenly coated with the third mixed solution; and drying is carried out to form a functional coating and obtain a composite separator. The first solvent and the second solvent may be the same as or different from each other. The solvents may be water, dimethylacetamide (DMAC), or the like.

Specifically, a coating method used includes gravure coating, bar coating, spray coating, or the like. One or two surfaces of the polymer film are coated with the mixed coating material. Then, drying and hot-press molding are carried out to obtain a composite separator.

The present disclosure provides an electrochemical apparatus, including the foregoing composite separator. The electrochemical apparatus in the present disclosure may be specifically a battery, for example, a lithium-ion battery or the like. Generally, the electrochemical apparatus includes an electrolyte solution, an electrochemical cell, and a packaging material packaging the electrochemical cell. The electrochemical cell includes a positive electrode plate, a negative electrode plate, and a composite separator between the positive electrode plate and the negative electrode plate. The electrochemical apparatus may be prepared according to a conventional method in the art. For example, the positive electrode plate, the composite separator, and the negative electrode plate that are described above are wound after being sequentially stacked or are stacked, to obtain the electrochemical cell; then, the electrochemical cell is packaged with the packaging material (for example, aluminum-plastic film or the like); the electrolyte solution is injected; and processes such as vacuum packaging, standing, formation, shaping, and sorting are carried out to obtain the electrochemical apparatus.

In the present disclosure, the composite separator is between the positive electrode plate and the negative electrode plate. Having good bonding performance, the composite separator can enhance bonding forces between the composite separator and the electrode plates, so that during charging and discharging of the battery, the composite separator and the electrode plates can be kept tightly bonded, and restrained from moving in a staggered manner. Therefore, phenomena such as fire breakouts and explosions caused by direct contact between the positive electrode plate and the negative electrode plate are avoided. In addition, the inorganic particles on the composite separator form a net structure under the action of a bonding force, thereby enhancing the thermal shrinkage-resistant performance and the stability of the composite separator.

Further, the positive electrode plate includes a positive electrode current collector and a positive electrode active material layer disposed on a surface of the current collector. The positive electrode active material layer includes a positive electrode active material, a binder, and a conductive agent. A mass percentage of the positive electrode active material ranges from 60% to 98%, for example, is 60%, 70%, 80%, 90%, 96%, 98%, or in a range formed by any two of the foregoing values. A mass percentage of the conductive agent ranges from 1% to 10%, for example, is 1%, 2%, 5%, 10%, or in a range formed by any two of the foregoing values. A mass percentage of the binder ranges from 1% to 10%, for example, is 1%, 2%, 5%, 10%, or in a range formed by any two of the foregoing values. The positive electrode active material may be selected from one or more of lithium cobalt oxide (LCO), lithium manganate oxide, lithium iron phosphate (LFP), a nickel-cobalt-manganese (NCM) ternary material, or a nickel-cobalt-aluminum (NCA) layered material. The positive electrode current collector may be aluminum foil whose principal component is aluminum, or a composite current collector formed by laminating aluminum foil and another material (for example, a polymer material or the like), or a composite current collector including aluminum foil and a conductive carbon layer on a surface of the aluminum foil, or the like. Generally, a mass percentage of aluminum in the aluminum foil is not less than 95%.

For example, in a preparation process of the positive electrode plate, a positive electrode active material, a binder, and a conductive agent are mixed according to a specified weight proportion, added with a solvent, for example, N-methylpyrrolidone (NMP) or water; the mixture is stirred under action of a vacuum mixer until a mixed system became a positive electrode slurry with uniform fluidity; the positive electrode slurry is evenly applied on aluminum foil having a thickness ranging from 8 μm to 15 μm; the aluminum foil coated with the positive electrode slurry is baked and dried in an oven, followed by rolling and cutting, to obtain the required positive electrode plate.

Further, the negative electrode plate includes a negative electrode current collector and a negative electrode active material layer disposed on a surface of the current collector. The negative electrode active material layer includes a negative electrode active material, a binder, and a conductive agent. A mass percentage of the negative electrode active material ranges from 60% to 98%, for example, is 60%, 70%, 80%, 90%, 96%, 98%, or in a range formed by any two of the foregoing values. A mass percentage of the conductive agent ranges from 1% to 10%, for example, is 1%, 2%, 5%, 10%, or in a range formed by any two of the foregoing values. A mass percentage of the binder ranges from 1% to 10%, for example, is 1%, 2%, 5%, 10%, or in a range formed by any two of the foregoing values. The negative electrode active material may be selected from one or more of artificial graphite, natural graphite, silicon, or silicon monoxide. The negative electrode current collector includes, for example, copper foil or the like.

For example, in a preparation process of the negative electrode plate, the negative electrode active material, the conductive agent, and the binder are added into a dispersing agent; a negative electrode slurry is prepared via a wet process; the negative electrode slurry is evenly applied on copper foil with a thickness ranging from 4 μm to 10 μm; and the copper foil coated with the negative electrode slurry is baked and dried in an oven, followed by rolling and cutting, to obtain the required negative electrode plate, where the dispersing agent may be, for example, sodium carboxymethyl cellulose (CMC).

In the present disclosure, the conductive agent may include at least one of conductive carbon black (SP), acetylene black, Ketjen black, carbon fiber, or the like; and the binder may be at least one of polyvinylidene fluoride (PVDF), a copolymer of vinylidene fluoride-hexafluoropropylene, polyamide, polyacrylonitrile, polyacrylic acid ester, polyacrylic acid, polyacrylate, sodium carboxymethyl cellulose (CMC), polyvinylpyrrolidone, polyvinyl ether, polymethyl methacrylate, polytetrafluoroethylene, polyhexafluoropropylene, or styrene-butadiene rubber (SBR).

Optionally, the foregoing electrolyte solution may include a non-aqueous electrolyte solution whose components may include a non-aqueous solvent and a lithium salt. The non-aqueous solvent may be a carbonate compound and/or a carboxylate compound, for example, at least one of ethylene carbonate, propylene carbonate, propyl propionate, or ethyl propionate. The lithium salt includes lithium hexafluorophosphate (LiPF₆) and/or lithium tetrafluoroborate (LiBF₄). In addition, the electrolyte solution may further contain an additive, which may be a conventional electrolyte additive in the art, for example, at least one of lithium trifluoromethyl triethyl borate, prop-1-ene-1,3-sultone, or fluoroethylene carbonate.

To make the objectives, technical solutions, and advantages of the present disclosure clearer, the technical solutions in the embodiments of the present disclosure are clearly described below with reference to the embodiments of the present disclosure.

Preparation processes of a positive electrode plate, a negative electrode plate, and an electrolyte solution used in the following examples are as follows.

### (1) Preparation of the Positive Electrode Plate

A positive electrode active material LiCoO₂, polyvinylidene fluoride (PVDF), acetylene black, and N-methylpyrrolidone (NMP) were mixed at a weight proportion of 96:2:2:65. The mixture was stirred under action of a vacuum mixer until a mixed system became a positive electrode slurry with uniform fluidity. The positive electrode slurry was evenly applied on aluminum foil having a thickness of 10 μm. The coated aluminum foil was baked in an oven having a temperature gradient of 85° C., 90° C., 105° C., 90° C., and 80° C. sequentially and then dried in an oven at 120° C. for 8 hours, followed by rolling and cutting, to obtain the positive electrode plate.

### (2) Preparation of the Negative Electrode Plate

An artificial graphite material, conductive carbon black (SP), sodium carboxymethyl cellulose (CMC), and styrene-butadiene rubber (SBR) were mixed at a mass ratio of 96:1:1:2. The mixture was stirred under action of a vacuum mixer until a mixed system became a negative electrode slurry. The negative electrode slurry was evenly applied on copper foil having a thickness of 5 μm. The coated copper foil was baked in a five-stage oven with different temperatures and then dried in an oven at 85° C. for 5 hours, followed by rolling and cutting, to obtain the negative electrode plate.

### (3) Preparation of the Electrolyte Solution

Ethylene carbonate, propylene carbonate, propyl propionate, and ethyl propionate were evenly mixed at a mass ratio of 1:2:5:2 in a glovebox filled with argon gas, and then quickly added with 1 mol/L (12.5 wt %) of fully dried lithium hexafluorophosphate (LiPF₆) and an additive (including a mixture of lithium trifluoromethyl triethyl borate, prop-1-ene-1,3-sultone, and fluoroethylene carbonate), to obtain the electrolyte solution.

### Example 1

### (1) Preparation of a Composite Separator

Aluminum oxide particles having D90₁ of 1.0 μm were added into deionized water, followed by 30 minutes' stirring and dispersing, to obtain a first mixed solution; then, polyvinylidene fluoride-hexafluoropropylene particles having D90₂ of 3 μm were added into deionized water, followed by 30 minutes' stirring and dispersing, to obtain a second mixed solution; and the first mixed solution was added into the second mixed solution, followed by evenly stirring and dispersing, to obtain a third mixed solution, where a mass ratio of the aluminum oxide particles to the polyvinylidene fluoride-hexafluoropropylene particles was 6:4 (namely, 1.5:1).

The third mixed solution was evenly applied on surfaces on two sides of a polyethylene microporous film (F07BC1, Toray Battery Separator Film Co., Ltd, air permeability value: 164 s) having a thickness of 7.1 μm via gravure coating, followed by drying, to obtain the composite separator having a total thickness of 11.1 μm, where thicknesses of the functional coatings on the surfaces on the two sides of the polyethylene microporous film were 2.0 μm and 2.0 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Example 2

### (1) Preparation of a Composite Separator

Boehmite particles having D90₁ of 0.4 μm were added into dimethylacetamide (DMAC); followed by 30 minutes' stirring and dispersing, to obtain a first mixed solution; then, polyvinylidene fluoride-hexafluoropropylene particles having D90₂ of 4 μm were added into DMAC, followed by 30 minutes' stirring and dispersing, to obtain a second mixed solution; and the first mixed solution was added into the second mixed solution, followed by evenly stirring and dispersing, to obtain a third mixed solution, where a mass ratio of the boehmite particles to the polyvinylidene fluoride-hexafluoropropylene particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the composite separator having a total thickness of 10.9 μm, where thicknesses of the functional coatings on the two sides of the polyethylene microporous film were 2.0 μm and 1.8 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Example 3

### (1) Preparation of a Composite Separator

Boehmite particles having D90₁ of 1.0 μm were added into deionized water, followed by 30 minutes' stirring and dispersing, to obtain a first mixed solution; polymethyl methacrylate particles having D90₂ of 3 μm were added into deionized water, followed by 30 minutes' stirring and dispersing, to obtain a second mixed solution; and the first mixed solution was added into the second mixed solution, followed by evenly stirring and dispersing, to obtain a third mixed solution, where a mass ratio of the boehmite particles to the polymethyl methacrylate particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the composite separator having a total thickness of 11.4 μm, where thicknesses of the functional coatings on the surfaces on the two sides of the polyethylene microporous film were 2.1 μm and 2.2 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Example 4

### (1) Preparation of a Composite Separator

Aluminum oxide particles having D90₁ of 1.0 μm were added into deionized water, followed by 30 minutes' stirring and dispersing, to obtain a first mixed solution; then, polyvinylidene fluoride-hexafluoropropylene particles having D90₂ of 3 μm were added into deionized water, followed by 30 minutes' stirring and dispersing, to obtain a second mixed solution; and the first mixed solution was added into the second mixed solution, followed by evenly stirring and dispersing, to obtain a third mixed solution, where a mass ratio of the aluminum oxide particles to the polyvinylidene fluoride-hexafluoropropylene particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the composite separator having a total thickness of 15.0 μm, where thicknesses of the functional coatings on the two sides of the polyethylene microporous film were 4.0 μm and 3.9 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Example 5

### (1) Preparation of a Composite Separator

Boehmite particles having D90₁ of 1.0 μm were added into deionized water, followed by 30 minutes' stirring and dispersing, to obtain a first mixed solution; polymethyl methacrylate particles having D90₂ of 3 μm were added into deionized water, followed by 30 minutes' stirring and dispersing, to obtain a second mixed solution; and the first mixed solution was added into the second mixed solution, followed by evenly stirring and dispersing, to obtain a third mixed solution, where a mass ratio of the boehmite particles to the polymethyl methacrylate particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the separator having a total thickness of 15.2 m, where thicknesses of the functional coatings on the two sides of the polyethylene microporous film were 4.1 μm and 4.0 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Group of Examples 6

The group of Examples were operated according to the method in Example 1. Differences lied in that mass ratios of the aluminum oxide particles to the polyvinylidene fluoride-hexafluoropropylene particles were different, and were specifically as follows:

Example 6-1: A mass ratio of the aluminum oxide particles to the polyvinylidene fluoride-hexafluoropropylene particles was 3:7.

Example 6-2: A mass ratio of the aluminum oxide particles to the polyvinylidene fluoride-hexafluoropropylene particles was 9:1.

Example 6-3: A mass ratio of the aluminum oxide particles to the polyvinylidene fluoride-hexafluoropropylene particles was 9.5:0.5.

### Example 7

The group of Examples were operated according to the method in Example 1. A difference lies in that the particle size D90₁ of the aluminum oxide particles was 1.5 μm.

### Comparative Example 1

### (1) Preparation of a Composite Separator

Aluminum oxide particles having D90₁ of 1.5 μm were added into deionized water, followed by 30 minutes' stirring and dispersing, to obtain a first mixed solution; then, polyvinylidene fluoride-hexafluoropropylene particles having D90₂ of 0.3 μm were added into deionized water, followed by 30 minutes' stirring and dispersing, to obtain a second mixed solution; and the first mixed solution was added into the second mixed solution, followed by evenly stirring and dispersing, to obtain a third mixed solution, where a mass ratio of the aluminum oxide particles to the polyvinylidene fluoride-hexafluoropropylene particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the composite separator having a total thickness of 11.2 μm, where thicknesses of the functional coatings on the two sides of the polyethylene microporous film were 2.0 μm and 2.1 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Comparative Example 2

### (1) Preparation of a Composite Separator

Boehmite particles having D90₁ of 0.4 μm were added into DMAC, followed by 30 minutes' stirring and dispersing, to obtain a first mixed solution; then, polyvinylidene fluoride-hexafluoropropylene particles having D90₂ of 0.4 μm were added into DMAC, followed by 30 minutes' stirring and dispersing, to obtain a second mixed solution; and the first mixed solution was added into the second mixed solution, followed by evenly stirring and dispersing, to obtain a third mixed solution, where a mass ratio of the boehmite particles to the polyvinylidene fluoride-hexafluoropropylene particles was 1.5:1.

The third mixed solution was evenly applied on surfaces on two sides of a polyethylene microporous film (F07BC1, Toray Battery Separator Film Co., Ltd) having a thickness of 7.1 m via gravure coating, followed by drying, to obtain the composite separator having a total thickness of 10.9 μm, where thicknesses of the functional coatings on the two sides of the polyethylene microporous film were 1.8 μm and 2.0 μm, respectively.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

### Comparative Example 3

(1) A polyethylene microporous film (F12BMS, Toray Battery Separator Film Co., Ltd, air permeability value: 165 s) having a thickness of 12 μm was used as a composite separator.

### (2) Preparation of a Lithium-Ion Battery

A positive electrode plate, the composite separator in step (1), and a negative electrode plate were sequentially stacked, followed by winding, to obtain a bare cell that had not undergone injection of an electrolyte solution; the bare cell was placed in an aluminum-plastic film shell; the electrolyte solution was injected into the bare cell; and after vacuum packaging, standing, formation, shaping, and sorting, the lithium-ion battery was obtained.

TABLE 1
Components of the composite separators in Examples 1 to 7 and Comparative Examples 1 to 3

| | | | | | | Thicknesses t of |
|---|---|---|---|---|---|---|
| | | | | | | functional |
| | | | | Inorganic | Organic | coatings |
| | Polymer | Inorganic | Organic | particle | particle | on two sides |
| Group | film | particle | particle | D90₁ (μm) | D90₂ (μm) | (μm) |
| Example 1 | Polyethylene | Aluminum | Polyvinylidene | 1 | 3 | 2.0/2.0 |
| | | oxide | fluoride- | | | |
| | | | hexafluoropropylene | | | |
| Example 2 | Polyethylene | Boehmite | Polyvinylidene | 0.4 | 4 | 2.0/1.8 |
| | | | fluoride- | | | |
| | | | hexafluoropropylene | | | |
| Example 3 | Polyethylene | Boehmite | Polymethyl | 1 | 3 | 2.1/2.2 |
| | | | methacrylate | | | |
| Example 4 | Polyethylene | Aluminum | Polyvinylidene | 1 | 3 | 4.0/3.9 |
| | | oxide | fluoride- | | | |
| | | | hexafluoropropylene | | | |
| Example 5 | Polyethylene | Boehmite | Polymethyl | 1 | 3 | 4.1/4.0 |
| | | | methacrylate | | | |
| Example | Polyethylene | Aluminum | Polyvinylidene | 1 | 3 | 2.1/2.0 |
| 6-1 | | oxide | fluoride- | | | |
| | | | hexafluoropropylene | | | |
| Example | Polyethylene | Aluminum | Polyvinylidene | 1 | 3 | 2.0/2.0 |
| 6-2 | | oxide | fluoride- | | | |
| | | | hexafluoropropylene | | | |
| Example | Polyethylene | Aluminum | Polyvinylidene | 1 | 3 | 2.0/1.9 |
| 6-3 | | oxide | fluoride- | | | |
| | | | hexafluoropropylene | | | |
| Example 7 | Polyethylene | Aluminum | Polyvinylidene | 1.3 | 3 | 2.0/2.0 |
| | | oxide | fluoride- | | | |
| | | | hexafluoropropylene | | | |
| Comparative | Polyethylene | Aluminum | Polyvinylidene | 1.5 | 0.3 | 2.0/2.1 |
| Example 1 | | oxide | fluoride- | | | |
| | | | hexafluoropropylene | | | |
| Comparative | Polyethylene | Boehmite | Polyvinylidene | 0.4 | 0.4 | 1.8/2.0 |
| Example 2 | | | fluoride- | | | |
| | | | hexafluoropropylene | | | |
| Comparative | Polyethylene | / | / | / | / | / |
| Example 3 | | | | | | |

### Test Example

Performance tests, cell winding verification, and cell performance tests were performed on the composite separators and the lithium-ion batteries in the foregoing Examples and Comparative Examples. Specific test methods are as follows.

### 1. Thickness Test for a Composite Separator

Cut out a separator sample having an area of 200 mm*200 mm; take 12 samples from the area of 200 mm*200 mm at intervals of 30 mm with a micrometer; test thicknesses of the separators to obtain 12 pieces of data; calculate an average value of the data; and use the average value as the thickness of the composite separator. Test results are shown in Table 2.

### 2. Air Permeability Value Test for a Composite Separator

Cut out test samples having edges of 100 mm from the composite separator; and carry out an air permeability value test with a Gurley test instrument. Test results are shown in Table 2.

### 3. Furnace Temperature Test for a Battery

Place the battery in a bake-out furnace, where an initial temperature in the oven ranges from 20° C. to 30° C., a heating rate is 5° C./min, the temperature is raised to 130° C. or 135° C., and the raised temperature is kept for 1 hour; and observe whether a fire breakout or thermal runaway occurs in the electrochemical cell. Test results are shown in Table 2.

### 4. 25° C. Cycling Test for a Battery

Under a temperature condition of 25° C., perform 800 times of charge-discharge cycles on the battery at a charge-discharge rate of 1 C/1 C and a charge-discharge cut-off voltage ranging from 3.0 V to 4.45 V; record a discharge capacity of the last cycle; divide the discharge capacity by a discharge capacity of the first cycle, to obtain a capacity retention rate; record a thickness of the battery after the cycles; and divide the thickness by a thickness of the battery before the cycles, to obtain a thickness change rate. Test results are shown in Table 2.

### 5. 45° C. Cycling Test for a Battery

Under a temperature condition of 45° C., perform 500 times of charge-discharge cycles on the battery at a charge-discharge rate of 1 C/1 C and a charge-discharge cut-off voltage ranging from 3.0 V to 4.45 V; record a discharge capacity of the last cycle; divide the discharge capacity by a discharge capacity of the first cycle, to obtain a capacity retention rate; record a thickness of the battery after the cycles; and divide the thickness by a thickness of the battery before the cycles, to obtain a thickness change rate. Test results are shown in Table 2.

TABLE 2
Performance tests for the composite separators and the lithium-
ion batteries in Examples 1 to 7 and Comparative Examples 1 to 3

| | | | | | Capacity | Capacity |
|---|---|---|---|---|---|---|
| | | | 130° C. | 135° C. | retention | retention |
| | | Air | furnace | furnace | rate after | rate after |
| | Thickness | permeability | temperature | temperature | 800 cycles | 500 cycles |
| Group | (μm) | value (s) | test | test | at 25° C. | at 45° C. |
| Example 1 | 11.1 | 235 | 100% pass | 100% pass | 83.10% | 82.70% |
| Example 2 | 10.9 | 241 | 100% pass | 100% pass | 82.90% | 81.90% |
| Example 3 | 11.4 | 239 | 100% pass | 100% pass | 84.10% | 82.90% |
| Example 4 | 16.1 | 256 | 100% pass | 100% fail | 83.20% | 81.60% |
| Example 5 | 15.2 | 227 | 100% pass | 100% fail | 83.00% | 81.40% |
| Example | 11.1 | 247 | 100% pass | 80% fail | 82.2% | 82.1 |
| 6-1 | | | | | | |
| Example | 11.1 | 232 | 100% pass | 100% pass | 80.9% | 80.3% |
| 6-2 | | | | | | |
| Example | 11.1 | 221 | 100% pass | 100% fail | 74.3% | 72.4% |
| 6-3 | | | | | | |
| Example 7 | 11.1 | 239 | 100% pass | 100% pass | 81.7% | 80.9% |
| Comparative | 11.2 | 243 | 100% fail | 100% fail | 76% | 69% |
| Example 1 | | | | | | |
| Comparative | 10.9 | 228 | 100% fail | 100% fail | 81.40% | 78.40% |
| Example 2 | | | | | | |
| Comparative | 12 | 165 | 100% fail | 100% fail | 71.30% | 67.50% |
| Example 3 | | | | | | |

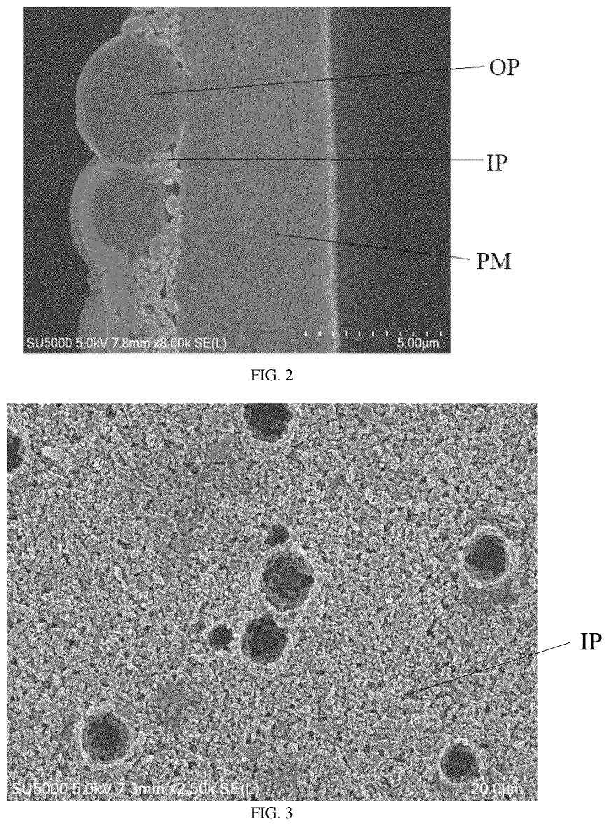

FIG. 1 and FIG. 2 are SEM images of a composite separator in Example 1 that are taken at different magnification factors. Protruded portions (OP) in FIG. 1 are organic particles. The organic particles are distributed discretely. As shown in FIG. 2, inorganic particles (IP) are attached on a surface of a polymer film (PM) by a large area; the inorganic particles (TP) are tightly connected to each other, thereby forming an inorganic support structure; and organic particles (OP) are discretely embedded in the inorganic support structure. FIG. 3 is an SEM image of a composite separator taken after a battery in Example 1 is disassembled. A plurality of holes are distributed on a surface of the composite separator. These holes are formed after organic particles are melted in a production process of the battery. Inorganic particles (TP) are dispersed around the holes.

It may be learned from Tables 1 and 2 that in Examples 1 to 7, when the particle size D90₁ of the inorganic particles and the particle size D90₂ of the organic particles satisfy: 0.01 D90₂≤D90₁≤0.5×D90₂, the inorganic particles form a network structure. The organic particles are discretely distributed in the inorganic particles. Therefore, the heat-resistant performance and the cycling performance of the battery can be greatly improved. Examples 4 and 5 differ from Example 1 in that when the thickness of the functional coating is greater than D90₂ of the organic particles, most organic particles are covered by the inorganic particles in the functional coating. As a result, the bonding performance between the functional coating of the composite separator and the electrode plate of the battery becomes poor; and the battery deforms easily during a furnace temperature test, causing a short circuit, a fire breakout, or a failure. Comparing Examples 6-1, 6-2, and 6-3 and Example 1, when a mass ratio of the inorganic particles to the organic particles is greater than 9:1, because a quantity of organic particles is small, a bonding force between the functional coating and the electrode plate of the battery becomes poor. As a result, the battery deforms easily during a furnace temperature test, causing a short circuit, a fire breakout, or a failure. Moreover, cycling is also affected. Example 2 differs from Comparative Example 2 in that when the coatings have the same thickness, in a case that D90₁ of the inorganic particles being less than D90₂ of the organic particles is not satisfied, the organic particles are easily filled in gaps among the inorganic particles. As a result, the bonding force between the functional coating and the electrode plate of the battery becomes poor; and the battery deforms easily during a furnace temperature test, causing a short circuit, a fire breakout, or a failure. Examples 1 to 7 and Comparative Examples 1 and 2 differ from Comparative Example 3 that the organic particles in the functional coating are bonded with the electrode plate of the battery, providing a good interface for even and short-distance conduction of ions in the battery. Therefore, the cycling performance of the battery is improved. In a case that 0.01×D90₂≤D901≤0.5×D90₂ is further satisfied, the batteries prepared in Examples 1 to 7 were endowed with better cycling performance. In summary, the safety and the cycle life of a battery can be improved and prolonged by controlling a relationship between particle sizes of inorganic particles and organic particles. By controlling a thickness t of a functional coating to satisfy D90₁<t<D90₂, a battery can pass a furnace temperature test having a higher temperature, thereby further improving the heat-resistant performance of the battery.

In summary, according to the composite separator in the present disclosure, the organic particles are discretely distributed in the inorganic particles, the particle sizes of the inorganic particles and the organic particles are adjusted, and the thickness of the coating of the composite separator is controlled. Therefore, the safety performance and the cycling performance of the battery can be greatly improved; and a technical application value is great.

The foregoing illustrates implementations of the present disclosure. However, the present disclosure is not limited to the foregoing implementations. Any modifications, equivalent replacements, improvements, or the like made without departing from the spirit and principle of the present disclosure shall fall within the protection scope of the present disclosure.

What is claimed is:

1. A composite separator, comprising a polymer film and a functional coating disposed on at least one surface of the polymer film; wherein the functional coating contains inorganic particles and organic particles; and
a particle size D90₁ of the inorganic particles and a particle size D90₂ of the organic particles satisfy: 0.01×D90₂≤D90₁≤0.5×D90₂, wherein D90₁ represents a particle size of inorganic particles at a cumulative volume of 90% from small particle sizes in the volume-based particle size distribution; and D90₂ represents a particle size of organic particles at a cumulative volume of 90% from small particle sizes in the volume-based particle size distribution.

2. The composite separator according to claim 1, wherein a ratio of a mass of the inorganic particles to a total mass of the inorganic particles and the organic particles is greater than 0 but not greater than 0.9.

3. The composite separator according to claim 1, wherein D90₁<t<D90₂; and t denotes a thickness of the functional coating.

4. The composite separator according to claim 1, wherein the inorganic particles contain at least one of aluminum oxide, boehmite, magnesium hydroxide, silicon dioxide, barium sulfate, zirconium oxide, calcium oxide, titanium dioxide, or cerium dioxide.

5. The composite separator according to claim 1, wherein the organic particles comprise an unmodified polymer and/or a modified polymer; the polymer contains at least one of polytetrafluoroethylene, polyvinylidene fluoride, polyvinylidene fluoride-hexafluoropropylene, polyacrylonitrile, polymethyl methacrylate, polyacrylic acid, polyacrylic acid ester, styrene-butadiene rubber, polyvinyl alcohol, polyvinyl acetate, polyacrylamide, phenolic resin, epoxy resin, waterborne polyurethane, polystyrene, polyethylene acrylate, an ethylene-vinyl acetate copolymer, an acrylic multicomponent copolymer, lithium polystyrene sulfonate, polyvinylidene difluoride-trichloroethylene, polyvinylidene difluoride-chlorotrifluoroethylene, or a copolymer; and the copolymer comprises a copolymer obtained by copolymerizing at least two of polytetrafluoroethylene, polyvinylidene fluoride, polyvinylidene fluoride-hexafluoropropylene, polyacrylonitrile, polymethyl methacrylate, polyacrylic acid, polyacrylic acid ester, styrene-butadiene rubber, polyvinyl alcohol, polyvinyl acetate, polyacrylamide, phenolic resin, epoxy resin, waterborne polyurethane, polystyrene, polyethylene acrylate, an ethylene-vinyl acetate copolymer, an acrylic multicomponent copolymer, lithium polystyrene sulfonate, polyvinylidene difluoride-trichloroethylene, polyvinylidene difluoride-chlorotrifluoroethylene, polyvinylidene fluoride-methacrylic acid, polystyrene-methacrylic acid, or polyethylene acrylate-methacrylate-methylstyrene; and
the modified polymer contains at least one of a polymethacrylate-vinylidene fluoride block copolymer, a maleic anhydride-grafted polystyrene polymer, or acrylate copolymerized and modified polyvinyl acetate.

6. The composite separator according to claim 1, wherein the polymer film contains polyolefin.

7. The composite separator according to claim 1, wherein an air permeability value of the polymer film ranges from 30 s to 1000 s; and/or
an air permeability value of the composite separator ranges from 30 s to 1000 s.

8. The composite separator according to claim 1, wherein a thickness a of the polymer film satisfies: 3 μm≤a≤25 m; and/or
a thickness b of the composite separator satisfies: 3 μm<b≤30 μm.

9. The composite separator according to claim 1, wherein a thickness b of the composite separator satisfies: 4 μm≤b≤30 μm.

10. The composite separator according to claim 1, wherein the particle size D90₁ of the inorganic particles satisfies: 0.01 μm<D90₁<10 m; and/or
the particle size D90₂ of the organic particles satisfies: 1 μm<D90₂<15 μm.

11. The composite separator according to claim 1, wherein D90₁ satisfies: 0.01 μm<D90₁≤7.5 μm; and/or
D90₂ satisfies: 2 μm≤D90₂<15 μm.

12. The composite separator according to claim 3, wherein t ranges from 0.5 μm to 10 μm.

13. The composite separator according to claim 3, wherein the thickness t of the functional coating ranges from 1 μm to 10 μm.

14. The composite separator according to claim 1, wherein 0.01 μm<D90₁≤1.5 μm.

15. An electrochemical apparatus, comprising the composite separator according to claim 1.

16. The electrochemical apparatus according to claim 15, wherein the electrochemical apparatus comprises a positive electrode plate and a negative electrode plate; and the composite separator is between the positive electrode plate and the negative electrode plate.

17. The electrochemical apparatus according to claim 15, wherein the electrochemical apparatus is a lithium-ion battery.
